(19) United States
(12) Patent Application Publication
(10) Pub. No.: US 2010/0111075 A1
(43) Pub. Date: May 6, 2010

(54) Main Apparatus and Bandwidth Allocating Method

(76) Inventor: Hideaki Nakai, Hino-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/603,309

(22) Filed: Oct. 21, 2009

(30) Foreign Application Priority Data
Oct. 31, 2008 (JP) 2008-281801

(51) Int. Cl. H04L 12/66

(52) U.S. Cl. 370/352

(57) ABSTRACT

According to one embodiment, a main apparatus includes a memory configured to store a priority information table showing correspondence relationships among the terminals or lines and priority of the use bandwidth on the communication network, a monitor module configured to monitor a use bandwidth on the communication network, and a controller configured to refer to priority corresponding to terminals or lines to be subjects of session establishment from the priority information table in session establishment, and allocate use bandwidth after the session establishment based on a reference result of the table and a monitor result from the monitor module.

### CROSS-REFERENCE TO RELATED APPLICATIONS

This application is based upon and claims the benefit of priority from Japanese Patent Application No. 2008-281801, filed Oct. 31, 2008, the entire contents of which are incorporated herein by reference.

### BACKGROUND

1. Field

One embodiment of the invention relates to a main apparatus for use in, for example, a Session Initiation Protocol (SIP) telephone system as an SIP server, and a bandwidth allocating method for use in the main apparatus.

2. Description of the Related Art

In recent years, an Internet Protocol (IP) telephone system interactively transmitting/receiving images and audio in real time as packet data via an IP network has become widely used. This IP telephone system may perform extension communication and trunk call origination/call termination among main apparatuses via the IP network as well as may perform inter-extension communication and trunk call origination call/call termination for each main apparatuses connected to the IP network. In this IP telephone system, SIP has been widely used as its protocol.

Meanwhile, in the SIP telephone system, the main apparatus is shared among a large number of terminals, personal computers, etc., on the IP network, thereby, it is fully foreseen for a processing load and a traffic load to become heavy in accordance with a video size or data size of a transmission, a use time zone and use environment. Increasing the processing load and the traffic load causes an affect of spoil of real time property on a service of communication connection, etc., among terminals corresponding to call origination and call termination.

Conventionally, in a communication system, a technique in which a bandwidth on the IP network may be preferentially used by receiving a bandwidth reservation message to temporarily register if it is settable and by registering priority in a priority communication table after session establishment (See, e.g., Jpn. Pat. Appin. KOKAI Publication No. 2007-311975).

Meanwhile, the technique of the above may register high priority under the same conditions for each user who transmits the bandwidth reservation message. Therefore, even if a communication traffic load on the IP network is heavy, for example, it is impossible to provide a fine-tuned service such that maintains communication quality for a certain user who has paid a high communication fee and such that allocates the residual bandwidth for other users.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view depicting an SIP telephone system regarding a first embodiment of the invention;

FIG. 2 is an exemplary view depicting an example of storage content in a priority information table depicted in FIG. 1;

FIG. 3 is an exemplary flowchart depicting a processing control procedure of a main apparatus in call origination in the first embodiment of the invention;

FIG. 4 is an exemplary sequence view for explaining session establishment operations in a case of high priority of a terminal on a call origination side in the first embodiment of the invention;

FIG. 5 is an exemplary sequence view for explaining session establishment operations in a case of low priority of the terminal on the call origination side in the first embodiment of the invention;

FIG. 6 is an exemplary flowchart depicting a processing control procedure of a main apparatus in a second embodiment of the invention;

FIG. 7A is an exemplary view depicting an example of first data in a variable priority information table in a third embodiment of the invention; and

FIG. 7B is an exemplary view depicting an example of second data in the variable priority information table in the third embodiment of the invention.

### DETAILED DESCRIPTION

Various embodiments according to the invention will be described hereinafter with reference to the accompanying drawings. In general, according to one embodiment of the invention, a main apparatus configured to be connected to a communication network to which a plurality of terminals or lines are connected, establish a session among the plurality of terminals, or among the terminals and the lines, and execute media communication including video and audio through the session, the main apparatus comprising: a memory configured to store a priority information table showing correspondence relationships among the terminals or lines and priority of the use bandwidth on the communication network; a monitor module configured to monitor a use bandwidth on the communication network; and a controller configured to refer to priority corresponding to terminals or lines to be subjects of session establishment from the priority information table in session establishment, and allocate use bandwidth after the session establishment based on a reference result of the table and a monitor result from the monitor module.

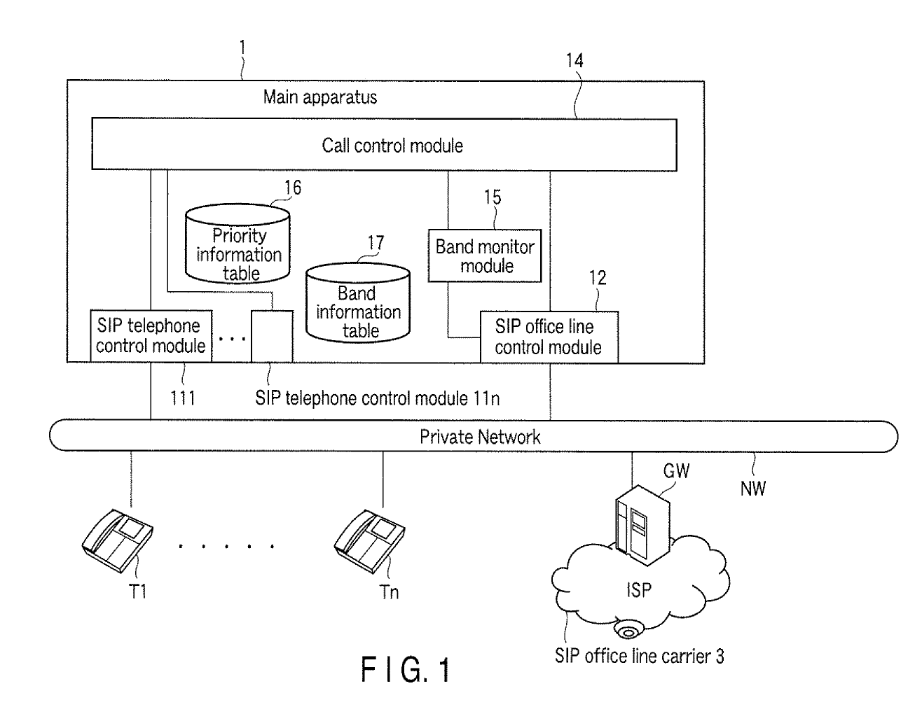

FIG. 1 shows a schematic configuration view of an SIP telephone system regarding a first embodiment of the invention, and a main apparatus 1 function as an SIP server. The main apparatus 1 accommodates a plurality of SIP telephone terminals T1-Tn (n is a natural number) via a private network NW such as a local area network (LAN). An SIP office line carrier 3 is connected to the network NW.

The main apparatus 1 includes SIP telephone control modules 111-11n (control modules 111-11n), an SIP office line control module 12 (control module 12), a call control module 14, a band monitor module 15, a priority information table 16 (table 16), and a band information table 17 (table 17).

The telephone control modules 111-11n perform interface processing to and from the plurality of SIP telephone terminals T1-Tn connected to the network NW.

The control module 12 performs interface processing to and from the SIP office line carrier 3 via the network NW and a gateway GW.

The call control module 14 performs call origination/call termination control, call termination transfer control, communication control of a state of each telephone terminal T1-Tn, etc.

The monitor module 15 periodically monitors the use bandwidth on the network NW to write the monitor information in the table 17.

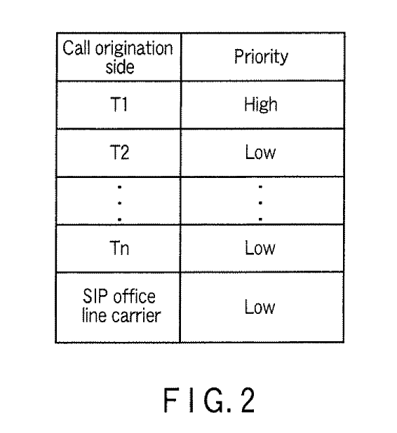

Data, showing correspondence relationships among the SIP telephone terminals T1-Tn and the office line carrier 3 to be call origination sides and the priority concerning to the use of the network NW, is stored in the table 16 as shown in FIG. 2.

Meanwhile, for example, when establishing a session between the SIP telephone terminal T1 and the office line carrier 3, the call control module 14 refers to the priority “high” corresponding to the telephone terminal T1 from the table 16. Further, the call control module 14 acquires information showing the use bandwidth from the table 17, and in this case, since the priority “high” is referred, the call control module 14 includes a function of allocating for example, a use bandwidth capable of performing media communication including audio and video.

The following will explain operations of the system configured as mentioned above.

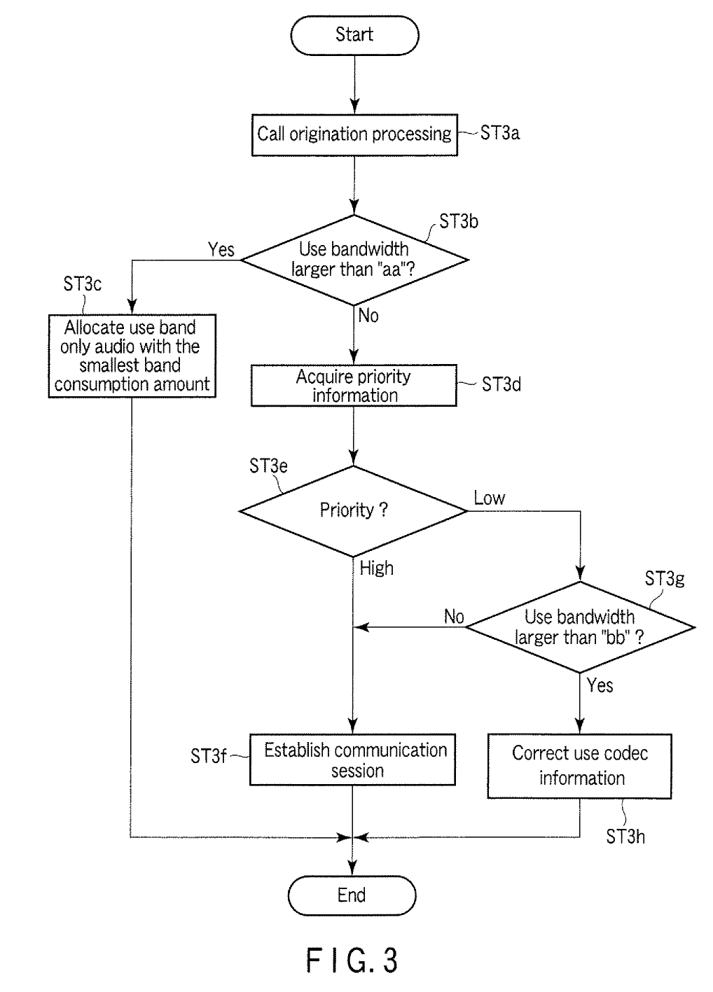

FIG. 3 shows a flowchart illustrating a processing control procedure of a main apparatus 1 in call origination.

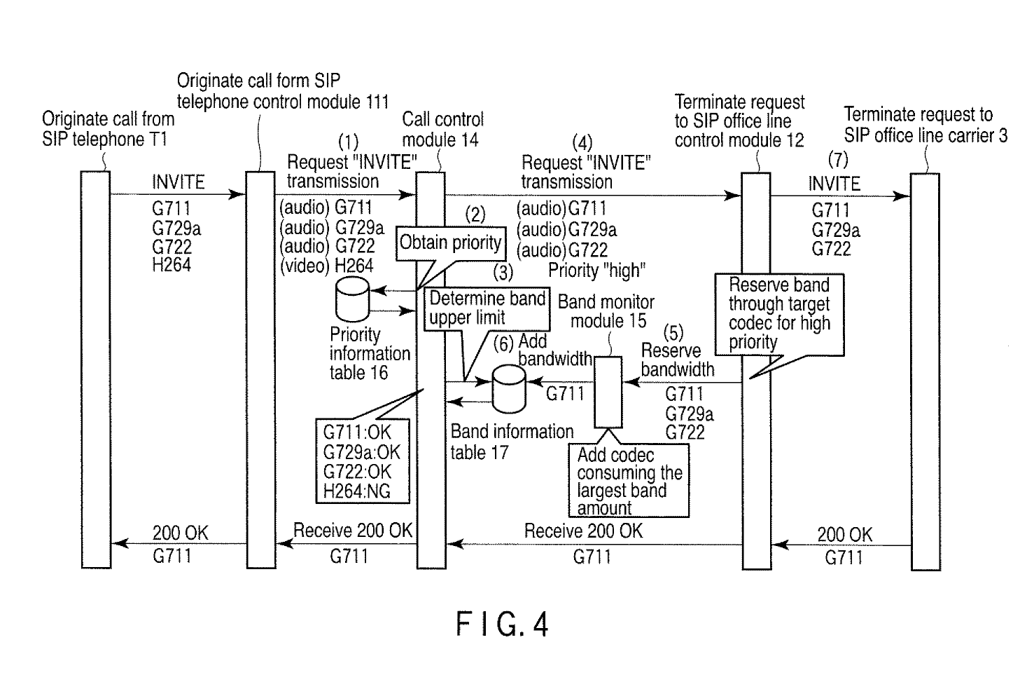

It is assumed that a user conducts a call origination operation by means of the telephone terminal T1 as shown in FIG. 4. Then, the telephone terminal T1 transmits an “INVITE” message to be its request signal to the main apparatus 1. Codec information such as G711 (audio), G729a (audio), G722 (audio) and H264 (video) is included in the “INVITE” message.

When receiving the “INVITE” message (Block ST3a), the main apparatus 1 acquires current bandwidth information from the table 17 to determine whether or not the use bandwidth is larger than “aa” (e.g., 95 percent of a bandwidth upper limit) (Block ST3b). If the use bandwidth is larger than “aa” (Yes, Block ST3b), the main apparatus 1 establishes a session in which a use bandwidth of solely audio having the smallest bandwidth consumption amount is allocated between the telephone terminal T1 and the office line carrier 3 to be call termination sides (Block ST3c).

Conversely, if the use bandwidth is not larger than “aa” (No, Block ST3b), the control module 111 adds received codec information to an “INVITE” message transmission request to transmit it to the call control module 14 (FIG. 4[1]).

The call control module 14 acquires the priority of the telephone terminal T1 on an origination side from the table 16 (Block ST3d and FIG. 4[2]). Since the priority “high” is acquired, the call control module 14 shifts the state from Block ST3e to Block ST3f, further acquires a current use bandwidth and a bandwidth upper limit value from the table 17, and determines whether or not communication may be performed based on the received codec information (FIG. 4[3]). If it is determined to be communicable, the call control module 14 adds the codec information and the priority information of a call origination terminal to the “INVITE” transmission request to transmit the request to the control module 12 on a call termination side (FIG. 4[4]). Here, it is assumed that the use bandwidth is larger than a threshold “bb” (e.g., 80 percent of the bandwidth upper limit) of the preset use bandwidth, and that the use of the H264 (video) is restricted.

If a call with priority “high” is originated, the control module 12 requires a reservation for a use bandwidth to the monitor module 15 in response to a subject codec (FIG. 4[5]).

The monitor module 15 adds the use bandwidth calculated from the codec (G711) consuming the largest bandwidth amount among the subject codecs to the table 17 (FIG. 4[6]).

After completing the bandwidth reservation, the control module 12 transmits the “INVITE” message to the SIP office line carrier 3 (FIG. 4[7]), and establishes the session by using a final 200 OK reception as a trigger.

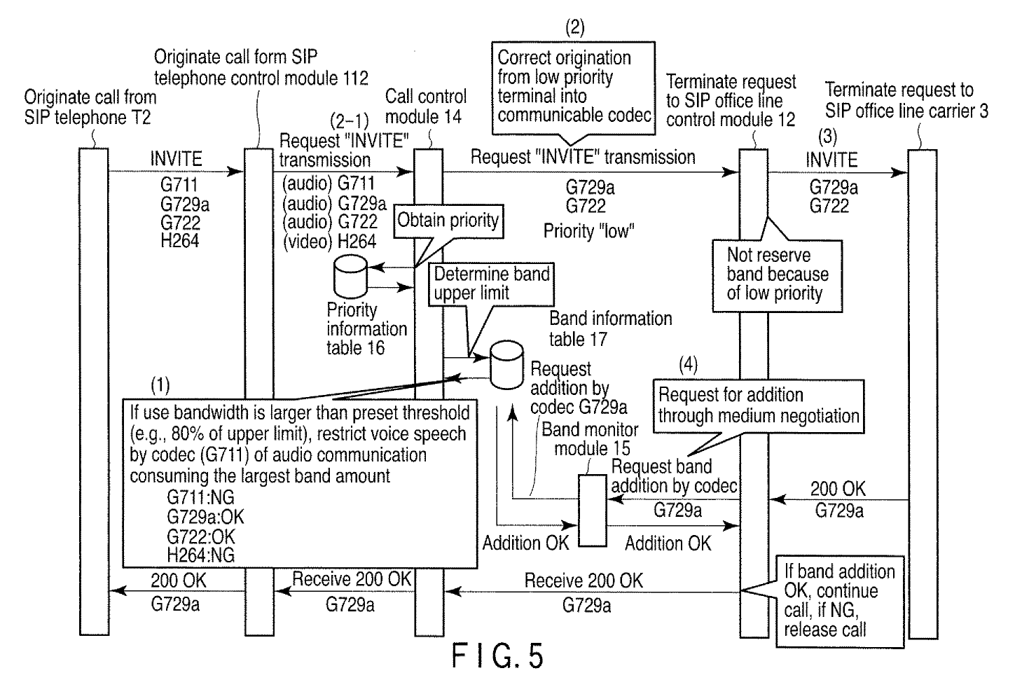

Meanwhile, in Block ST3e, in a case in which the telephone terminal T2 is set on the call origination side as shown in FIG. 5, since the priority is obtained as priority “low”, the call control module 14 determines whether or not the use bandwidth is equivalent to the value “bb” (e.g., larger than 80 percent of the bandwidth upper limit) of the preset number of bandwidth (Block ST3g).

If the obtained value of the use bandwidth is larger than the threshold “bb” (Yes, Block ST3g), the call control module 14 restricts the use of the codec consuming the largest bandwidth amount (Block ST3h). After this, similarly, in the way of the above, the call control module 14 adds the corrected codec information and codec information and the priority information of the call origination terminal to the “INVITE” transmission request to transmit the request to the control module 12 on the call termination side (FIG. 5[2]).

When a call with priority “low” is originated, the control module 12 does not reserve the bandwidth for the monitor module 15 and transmits the “INVITE” message to the office line carrier 3 (FIG. 5[3]).

Upon reception of 200 OK, the control module 12 requests for addition of the use bandwidth based on the received codec information (G729a) to the monitor module 15 (FIG. 5[4]).

When the bandwidth addition through the monitor module 15 has been completed normally, the session is established as usual.

In Block ST3g, if the obtained value of the use bandwidth is not larger than the threshold “bb” (No, Block ST3g), the call control module 14 shifts the state to Block ST3f.

As given above, in the first embodiment, the band monitor module 15 monitors the use bandwidth of the private network NW, the call control module 14 uses the table 16 showing the correspondence relationships among the SIP telephone terminals T1-Tn or the SIP office line carrier 3 on the call origination side and the priority to enable performing video transmission to the terminal or the line with the high priority or enable maintaining the communication quality. Further, the call control module 14 corrects the use codec information so that the restricted bandwidth can be used for the telephone terminals or lines with the low priority when the use bandwidth exceeds the threshold.

Therefore, this SIP telephone system can effectively use the bandwidth preset in response to the priority, and provide a fine-tuned communication service to each user.

### Second Embodiment

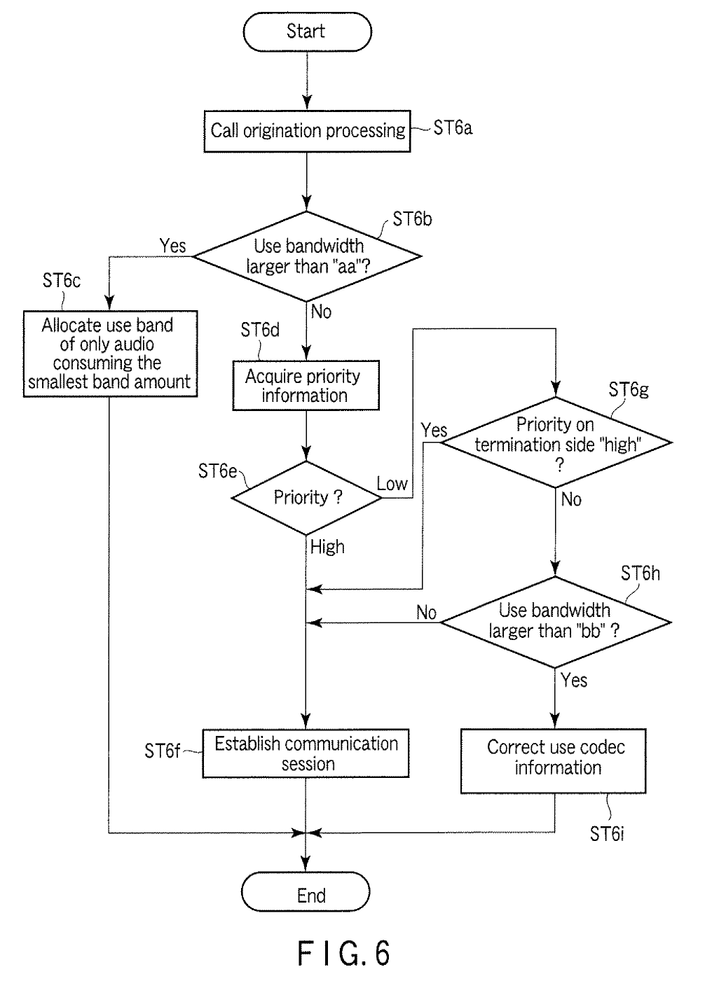

FIG. 6 shows a flowchart illustrating a processing control procedure of the main apparatus 1 in a second embodiment of the invention.

It is assumed that a user conducts a call origination operation to the SIP telephone terminal T1 by means of the SIP telephone terminal T2. Then, the telephone terminal T2 transmits the “INVITE” message to be its request signal to the main apparatus 1.

When receiving the “INVITE” message (Block ST6a), the main apparatus 1 acquires the current bandwidth information from the table 17 to determine whether or not the use bandwidth is equal to “aa” (e.g., 95 percent of the bandwidth upper limit) or larger (Block ST6b). If the use bandwidth is equal to “aa” or larger (Yes, Block ST6b), the main apparatus 1 establishes the session with a use bandwidth for solely audio allocated thereto between the telephone terminal T2 and the telephone terminal T1 to be the call termination side (Block ST6c).

Conversely, the use bandwidth is not larger than “aa” (No, Block ST6b), the control module 111 of the main apparatus 1 adds the received codec information to the “INVITE” transmission request to transmit the request to the call control module 14.

The call control module 14 acquires the priority of the telephone terminal T2 on the call origination side from the table 16 (Block ST6d). Since the priority is set as “low”, the call control module 14 shifts the state from Block St6e to Block ST6g, and there, the call control module 14 determines the priority of the SIP telephone terminal T1 in accordance with the table 16 (Block ST6g).

Since the priority is set as “high”, the call control module 14 shifts the state from Block ST6g to Block ST6f, further obtains the current use bandwidth and the bandwidth upper limit value from the band information table 17, and determines whether or not the communication is enabled based on the received codec information. If it is determined that the communication is enabled, for example, the session for making media communication including audio and video is established.

Conversely, in Block ST6g, if the priority is set as “low” for the telephone terminal T1 on the call termination side, the call control module 14 shifts the state to process in Block ST6h.

As described above, according to the second embodiment, if the priority of the telephone terminal T1 on the call termination side is higher than that of the telephone terminal T2 on the call origination side, for example, since the use bandwidth enabling the media communication including the audio and video may be allocated, the improvement of the reliability on the allocation of the use bandwidth is further achieved.

### Third Embodiment

In a third embodiment of the invention, the main apparatus 1 stores a plurality of items of data differing in registration content in the table 16, and automatically changes the registration content in the table 16 by switching the data depending on a time zone.

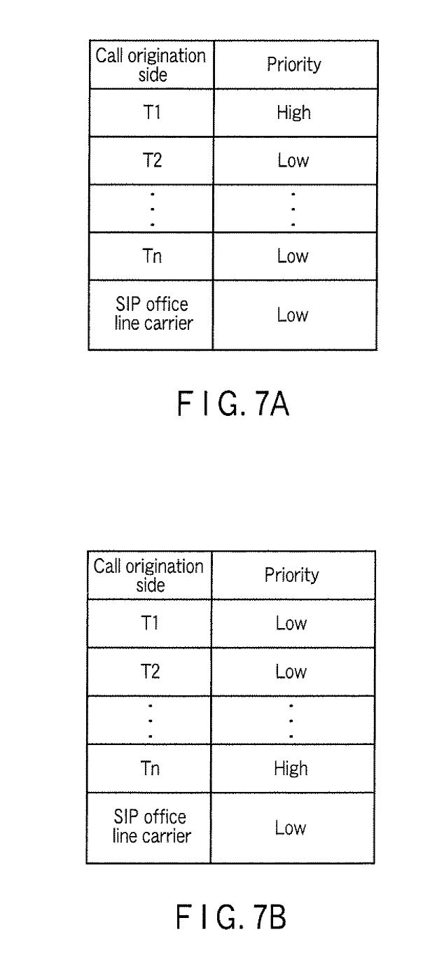

For instance, it is assumed that tow items of data composed of first data shown in FIG. 7A and second data shown in FIG. 75 has been prepared. In the data of FIG. 7A, the priority corresponding to the SIP telephone terminal T1 is set to “high”, and conversely, in the data of FIG. 7B, the priority corresponding thereto is set to “low”.

In this state, for example, when the time reaches 17:00 O'clock, the call control module 14 switches the table 16 from the first data to the second data, and when the time reaches 9:00 O'clock, it switches the table 16 from the second data to the first data. Thereby, the priority corresponding to the call termination side may be automatically changed according to the time zone. As regards a switching condition of the data, it is possible to use, a communication network, a group, etc., to be connected at a time zone other than the aforementioned time zone.

### Other Embodiment

The invention is not limited to the foregoing each embodiment. For instance, the invention may be an IP telephone system in which the telephone terminals on the call termination side and their priority may be associated with one another.

Further, while each of the foregoing embodiments has been described by taking the SIP telephone terminal as the example, the invention may be applied to a key telephone set.

Moreover, the configuration and the kind of the telephone system, the functional configuration of the main apparatus, the kind of the terminal of the SIP telephone terminal, the procedure and its content of the allocation of the bandwidth, etc., may be embodied in various forms without departing from spirit of the concept thereof.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A main apparatus configured to be connected to a communication network to which a plurality of terminals or lines are connected, establish a session among the plurality of terminals, or among the terminals and the lines, and execute media communication including video and audio through the session, the main apparatus comprising:
a memory configured to store a priority information table showing correspondence relationships among the terminals or lines and priority of the use bandwidth on the communication network;
a monitor module configured to monitor a use bandwidth on the communication network;
and a controller configured to refer to priority corresponding to terminals or lines to be subjects of session establishment from the priority information table in session establishment, and allocate use bandwidth after the session establishment based on a reference result of the table and a monitor result from the monitor module.

2. The apparatus of claim 1, wherein the controller refers to priority corresponding to terminals or lines on a call origination side from the priority information table.

3. The apparatus of claim 1, wherein the controller refers to priority corresponding to terminals or lines on a call origination side from the priority information table, and also refers to priority corresponding to terminals or lines on a call termination side from the priority information table.

4. The apparatus of claim 1, wherein the controller allocates a use bandwidth of audio in a case in which a request for the media communication including the video and the audio are issued and the use bandwidth of the communication network exceeds a threshold from a monitor result of the monitor module.

5. The apparatus of claim 1, further comprising:
a change module configured to dynamically change registration content in the priority information table based on prescribed conditions.

6. The apparatus of claim 5, wherein the change module uses at least one of a communication network, a group, and a time zone to be connected for determining the conditions.

7. A bandwidth allocating method for use in a main apparatus configured to be connected to a communication network to which a plurality of terminals or lines are connected, establish a session among the plurality of terminals or among the terminals and the lines, and execute media communication including video and audio through the session, the bandwidth allocation method comprising:
storing a priority information table showing correspondence relationships among the terminals or the lines and priority of the use bandwidth on the communication network in a memory;
monitoring the use bandwidth on the communication network; and
referring to priority corresponding to terminals or lines to be subjects of session establishment from the priority information table in the session establishment, and allocating use bandwidth after the session establishment based on a reference result of the table and a monitor result of the use bandwidth of the communication network.
